(19) United States
(12) Patent Application Publication
(10) Pub. No.: US 2005/0077222 A1
(43) Pub. Date: Apr. 14, 2005

(54) Sealed integral liquid chromatography system

(76) Inventors: Peter Alexander Dawes, Warrandyte (AU); Ernest Frederick Dawes, East Melbourne (AU)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/501,981

(22) PCT Filed: Jan. 16, 2003
(86) PCT No.: PCT/AU03/00049

(30) Foreign Application Priority Data
Jan. 17, 2002 (AU) PS 0016

(51) Int. Cl. B01D 15/08

(52) U.S. Cl. 210/198.2; 422/70; 73/61.52

(57) ABSTRACT

A liquid chromatography system (10) including a separation column (12) having an internal bore (13) and an end fitting assembly (16, 18, 20) fitted at one side to an end of the separation column (10). Transfer tubing (22) is fitted to the opposite side of the end fitting assembly (16, 18, 20). The separation column (12), transfer tubing (22), and end fitting assembly (16, 18, 20) are constructed as a sealed integral system. Preferably, the separation column is a micro, capillary, or nano liquid chromatography column.

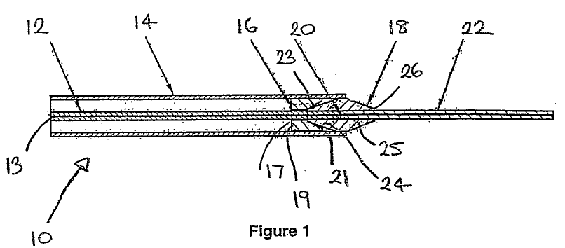

### FIELD OF THE INVENTION

The present invention relates to liquid chromatography and in particular to capillary and micro liquid chromatography columns.

### BACKGROUND OF THE INVENTION

Liquid chromatography is used for separation of certain compounds by their interaction with a packed bed in a separation column. The molecules to be separated are dissolved in a liquid mobile phase that is pumped through the packed bed, which is packed tightly, usually into a tube.

In its most basic form a liquid chromatography system typically comprises a pump to generate the flow and high pressure necessary to force the liquid mobile phase through the separation column. An injection valve then introduces a measured amount of the sample to be analysed into the liquid mobile phase stream. There may be a pre-column or in-line filter after the injection valve to remove particulate matter or material from the liquid mobile phase that may damage the separation column. The liquid mobile phase is pumped through the separation column under high pressure where chemical compounds are separated. The effluent of the separation column, including the separated compounds, are then carried via a transfer line to a detection system that is used to measure and quantitate the separated sample components.

Between each of the components in the liquid chromatography system there are typically connections made to transfer lines to take the liquid flow from one component of the system to the next. The flow path of the liquid therefore includes several joints which must be sealed against high pressure without introducing dead volumes and multiple flow paths to the flow path.

Within a conventional separation column design there are connections from the connecting tubing, to the column endfitting (usually containing a frit), between the endfitting and the separation column itself, and then the same is repeated on the other end of the separation column. Frit devices are required to keep the particulate separation media contained within the separation column.

Existing separation columns were designed when liquid chromatography columns were large, greater than 2.0 mm inside diameter, for example. The relatively large flow rates meant that components were less critical to join without introducing deleterious affects to the performance of the system. Although it is not yet fully defined, common terminology in this area refers to microbore as between 0.5 mm-2.0 mm internal diameter, capillary bore as between 0.15 mm-0.5 mm internal diameter, and nanobore as less than 0.15 mm. These smaller liquid chromatography systems are becoming more commonplace and a better approach is needed to obtain good performance of the liquid chromatography system and to ensure that the making of connections for the less skilled practitioner is less critical.

It is therefore an object of this invention to provide a liquid chromatography system incorporating low volume and zero dead volume connections.

### SUMMARY OF THE INVENTION

The invention accordingly provides a liquid chromatography system including:
a separation column having an internal bore;
an end fitting fitted at one side to an end of the separation column; and
transfer tubing fitted to the opposite side of the end fitting;
wherein the separation column, transfer tubing, and end fitting are constructed as a sealed integral system.

Preferably, the separation column is a micro, capillary, or nano liquid chromatography column. More preferably, the internal diameter of the internal bore of the separation column is in the range 0.025 mm-2.1 mm.

The end fitting preferably includes a double ferrule or employs a similar method of sealing the fitting at high pressure. Preferably, the double ferrule incorporates a frit.

The end fitting advantageously includes a zero volume connection between the separation column, transfer tubing, and a frit within the double ferrule or similar sealing means.

The double ferrule preferably includes central bore which aligns with the bore of the separation column and the bore of the transfer tubing when the system is assembled. The double ferrule is preferably formed as a double-conical shaped component, tapering from the middle of the ferrule to either end of the ferrule.

The frit of the double ferrule may be a wire mesh frit or a polymer or metal frit formed in the ferrule, or an in-situ frit formed inside the separation column itself.

The liquid chromatography system preferably further includes a protective outer tubular sheath surrounding the separation column, and preferably extending over at least part of the double ferrule. The sheath may be made of metal and serves to give strength to the system and prevent the small outside diameter separation column from being damaged in use.

In preparation of the separation column it is necessary to form and seal the double ferrule into the separation column and the transfer tube at the same time. For this purpose a backing ferrule may be used. The backing ferrule becomes a permanent feature of the chromatography column when assembled as it cannot be removed.

Preferably the separation column is made of glass lined metal tubing or fused silica lined polymer tubing, or any other suitable material.

A transfer or connecting tubing is provided on the other side of the double ferrule. Advantageously, the transfer tubing is received within the bore of the double ferrule and also extends midway along the length of the double ferrule up to the side of the frit opposite the separation column. The bore of the double ferrule may be stepped to accommodate a separation column and transfer tubing of different outer diameters.

Advantageously, the double ferrule is permanently collapsed so as to fix the capillary column into one end and the transfer tubing into its other end.

In one embodiment of the invention, the separation column, end fitting, and transfer tubing are permanently joined by gluing, welding or other fixing means into a single unit.

### BRIEF DESCRIPTION OF THE DRAWING

The invention will now be described by way of example, with reference to the accompanying drawing which is a side cross-sectional view of an integral liquid chromatography column according to an embodiment of the invention.

### DESCRIPTION OF PREFERRED EMBODIMENTS

Referring to the drawing there is illustrated a liquid chromatography system 10 according to an embodiment of the invention. The system 10 includes separation column 12, outer protective sheath 14, backing ferrule 16, double ferrule 18 incorporating frit 20, and transfer or connecting tubing 22 to other devices such as the sample introduction valve and detector (not shown). The backing ferrule 16, double ferrule 18, frit 20, and transfer tubing 22 are repeated at the opposite end (not shown) of the separation column 12.

Separation column 12 is preferably either a micro, capillary, or nano liquid chromatography column. The separation column 12 is preferably made of glass lined metal tubing or fused silica lined polymer tubing but other precise, smooth and inert bore tubing materials may be used. The internal bore 13 of the column 12 is tightly packed with packing material (not shown). The separation column 12 is contained within protective sheath 14 that extends along the length of the column 12 and covers at least part of the double ferrule 18 as discussed below. Sheath 14 is advantageously made of a polymer or metal and serves to reduce accidental damage to the separation column 12.

Backing ferrule 16 is provided at each end of the separation column 12 (only one end is illustrated). The backing ferrule is used in forming the double cone ferrule onto the separation column 12 but can be removed on the first end formed but is trapped unable to be removed on the second end formed. It performs no subsequent function. Backing ferrule 16 includes a central bore 17 sized to receive the separation column 12. The outer diameter of the backing ferrule is sized to be closely received within the outer sheath 14. The side 19 of the backing ferrule 16 facing the separation column 12 is generally perpendicular to the axis of the separation column, while the other side 21 of the backing ferrule is shaped as a hollow cone 23, as illustrated, to receive one side 24 of the double ferrule 18 and to form the ferrule 18 into a permanent seal onto the separation column 12.

Double ferrule 18 is formed as a double-sided conical component, tapering from the middle of the component to each side 24, 25. The double ferrule also includes a central bore 26 extending therethrough. A first side 24 of the double ferrule is tightly received within the hollow conical portion 23 of backing ferrule 16. Sheath 14 advantageously extends up to midway along the double ferrule.

The cones on each end of the double ferrule must make a reliable high pressure seal onto the transfer tubing and separation column. The shape and dimensions of the two cones are not necessarily the same and depend on the tubing they are sealing onto and the dimensions of the tubing.

To create the necessary perfect flow conditions in small volume liquid chromatography the bore of the separation column and the transfer tubing must be perfectly aligned. The concentricity of the bore of the tubing as well as the inside bore of the connecting union and its precise diameter are critical to within a few micrometers. Using conventional designs of liquid chromatography fittings and conventional machining techniques it would be difficult and expensive to achieve the required level of tolerances. The small size, machining from one direction, simple design, and tendency to automatically align the connecting tube, makes the double ferrule arrangement a simple low cost component that can be produced inexpensively on large quantity compared with conventional liquid chromatography fitting designs.

The frit 20 is captured in the double ferrule 18 either as a wire mesh frit or a polymer or metal frit formed in the ferrule 18. Frit 20 is a flat circular disc with a plurality of holes that acts as a filter of the packing material. The frit 20 is preferably located in or near the middle of the double ferrule 18. The separation column preferably extends through the backing ferrule 16, and into the double ferrule 18 up to the frit 20. In a further embodiment the frit 20 can be incorporated within the end of the separation column 12 or in the connecting tubing 22.

The second side 25 of the double ferrule extends from the cover of the sheath 14 and receives one end of transfer or connecting tubing 22. The transfer tubing preferably extends into the double ferrule 18 up to and in close contact with the side of the frit opposite the separation column 12 The double ferrule 18 is permanently collapsed so as to fix the separation column 12 into one end 24 and the transfer tubing 22 into its other end 25.

A double cone ferrule is not the only way of forming a permanent connection between the separation column 12, frit 20 and the transfer tubing 22 or other components in the system. The integrated column system can be formed by various other fixing means other than ferrule swaging. Adhesives and certain welding processes would also be suitable for forming the integrated separation column, frit and transfer tubing system.

Ideally the tubing of the separation column 12 and transfer tubing 22 should have an outside diameter as small as possible. A small outside diameter reduces the annular area at connections proportional to the square of the diameter, which helps reduce unwanted dead volumes within the system. Smaller outside diameters also allow for more precise fits with reduced scope for errors in concentricity or annular areas. Existing systems have typically had column outside diameters from 1/16″ to 1/8″.

The ferrule 18 is designed and is of small enough dimension to permit machining to the very precise dimensions and concentricity required in the join between the separation column 12 and transfer tubing 22. The bore of the double ferrule may be stepped to accommodate a separation column and transfer tubing of different outer diameters.

The integrated liquid chromatography column can be produced using various diameter components and materials, for example, 1/16″ outer diameter (OD) glass lined metal tubing (GLT), 0.635 mm O.D. GLT, 1/16″ OD PEEKSIL and 1/32″ OD PEEKSIL for the column tubing material. PEEKSIL is a fused silica capillary tube coated with PEEK (polyetheretherketone). The inside diameter of the separation column is typically between 0.025 mm and 2.1 mm.

The transfer tubing 22 is preferably either 1/16″ OD or 1/32″ OD fused silica lined PEEK which has an inside diameter of between 0.010 mm and 0.100 mm. Another suitable connecting tubing material is fused silica tubing with 0.010 mm to 0.100 mm inside diameter range and an outer protective coating of polyimide to give approximately 0.35 mm OD.

It will be appreciated that the chromatography column of the invention is designed to incorporate all critical elements of the column into a permanently sealed fitting. In this way the column can be designed to achieve ideal flow path properties because there is no need to make the system in several pieces as is the usual practice in liquid chromatography fittings. Typical error build-ups in assembly of the system is therefore not an issue. It will also be appreciated that the double ferrule of the system is an easy component to machine in very high volume and is therefore a much less expensive way to produce a liquid chromatography column.

It will be understood that the invention disclosed and defined in this specification extends to all alternative combinations of two or more of the individual features mentioned or evident from the text or drawings. All of these different combinations constitute various alternative aspects of the invention.

1. A liquid chromatography system including:
a separation column having an internal bore;
an end fitting fitted at one side to an end of the separation column; and
transfer tubing fitted to the opposite side of the end fitting;
wherein the separation column, transfer tubing, and end fitting are constructed as a sealed integral system.

2. A system according to claim 1, wherein the separation column is a micro, capillary, or nano liquid chromatography column.

3. A system according to claim 1, wherein the internal diameter of the internal bore of the separation column is in the range 0.025 mm-2.1 mm.

4. A system according to claim 3, wherein the internal diameter of the internal bore of the separation column is in the range 0.030 mm-1.0 mm.

5. A system according to claim 1 wherein the liquid chromatography system further includes a protective outer tubular sheath surrounding the separation column.

6. A system according to claim 5, wherein the end fitting includes a double ferrule incorporating a frit.

7. A system according to claim 6, wherein the double ferrule includes central bore which aligns with the bore of the separation column and the bore of the transfer tubing when the system is assembled.

8. A system according to claim 6, wherein the double ferrule is formed as a double-conical shaped component, tapering from the middle of the ferrule to either end of the ferrule.

9. A system according to claim 6, wherein the bore of the double ferrule is stepped to accommodate a separation column and transfer tubing of different outer diameters.

10. A system according to claim 6, wherein the double ferrule is permanently collapsed so as to fix the capillary column into one end and the transfer tubing into its other end.

11. A system according to claim 6, wherein the frit of the double ferrule is a wire mesh frit or a polymer or metal frit formed in the ferrule.

12. A system according to claim 6, wherein the frit is formed inside the end of the separation column or transfer tubing.

13. A system according to claim 6, wherein the separation column extends midway along the bore of the double ferrule up to one side of the frit.

14. A system according to claim 13, wherein the transfer tubing is received within the bore of the double ferrule and extends midway along the length of the double ferrule up to the side of the frit opposite the separation column.

15. A system according to claim 1, wherein the separation column is made of glass lined metal tubing or fused silica lined polymer tubing.

16. A system according to claim 1, wherein the separation column, end fitting, and transfer tubing are permanently joined by gluing, welding or other fixing means into a single unit.
